(19) United States
(12) Patent Application Publication
(10) Pub. No.: US 2009/0096572 A1
(43) Pub. Date: Apr. 16, 2009

(54) BREACH CONTROL BARRIER SYSTEM

(76) Inventors: Todd Bosik, Jockvale (CA); Neil Grant, Crysler (CA); Gary Roberts, Greely (CA)

Correspondence Address: HAYES SOLOWAY P.C., 3450 E. SUNRISE DRIVE, SUITE 140, TUCSON, AZ, 85718, US

(21) Appl. No.: 12/205,828

(22) Filed: Sep. 5, 2008

Related U.S. Application Data
(60) Provisional application No. 60/970,140, filed on Sep. 5, 2007.

(51) Int. Cl. G08B 29/00

(52) U.S. Cl. 340/5.7

(57) ABSTRACT

This invention relates to the field of personnel access control and more particularly, to deployable/stowable fabric-based barriers for controlling or restricting access of individuals to specific physical areas. This allows security personnel at a screening station, for example, to quickly react to an “intruder” who is bypassing the screening area by quickly and safely closing the passageway and/or walkways between a screening area and a sterile area. Recognizing that different facilities and different applications place more emphasis on some design requirements than others, three barrier systems were designed to increase overall suitability for different facilities: Drop Down BCBS, Pop Across BCBS, and Pop Up BCBC.

### FIELD OF INVENTION

This invention relates to the field of personnel access control. More particularly, this application describes deployable/stowable barriers for controlling or restricting access of individuals to specific physical areas.

### BACKGROUND OF THE INVENTION

Personnel access control systems or barriers have existed for many years, but historically were implemented in obscure and specialized environments such as in high security office buildings. These previous personnel barrier and access control systems have incorporated some form of gate or door, which is designed to be deployed manually to restrict passage of pedestrians into the controlled area. These access control systems were designed to meet basic performance requirements such as the ability to close off a conventional hallway (rather than an atrium, for example) and to meet specified strength requirements when closed. There was no concern for other performance issues such as speed of deployment and safety of deployment, with even less emphasis being placed on how the systems could be incorporated in large atriums.

Today there is a demand for personnel access control systems in a completely different setting, which has a completely different set of design parameters. The previous systems typically do not satisfy any of the design concerns for implementation in public areas such as airports, subway stations, courthouses, government offices serving the public, and laboratories, to name but a few. These environments typically require the following:

quick deployment, on the order of 2-4 seconds;

a design which can be incorporated in areas ranging from narrow corridors, to wide atriums;

integration with a complete barrier system;

integration with building structure;

aesthetically pleasing and/or inconspicuous;

consistent with public safety concerns, particularly during activation;

in compliance with building fire and safety codes;

strength;

having minimum or no impact on throughput particularly in high traffic situations; and

reasonable cost, including cost of fabrication, installation, maintenance and staffing.

There is therefore a need for an improved personnel barrier design and system, which addresses one or more of the problems outlined above.

### SUMMARY OF THE INVENTION

In facilities where individuals are screened for security purposes, prior to entering a specific area, the area on the downstream side of the screening process is considered “sterile”. All personnel within that area have been screened by security personnel (for weapons or explosives) or have been pre-approved for entry. If an individual deliberately or inadvertently bypasses the screening area and enters the “sterile” area it is considered “contaminated”. A dangerous person or material/device may have been introduced to the sterile area by the intruder thereby compromising the safety of the area.

As a result of this breach:

the area must be evacuated;

the area must be inspected to ensure that no dangerous materials/devices have been introduced into the area by the “intruder”; and

all personnel have to be re-screened prior to re-entering the area.

The present invention, which is referred to as the Breach Control Barrier System (BCBS) in this application, allows security personnel at a screening station (at an airport, for example) to quickly react to an “intruder” who is bypassing the screening area by quickly and safely closing the passageway and/or walkways between the screening area and the sterile area. Specifically, the objective of the BCBS is to delay deliberate or inadvertent intruders long enough for facility security forces to permanently restrain and/or capture the intruder.

The performance of the BCBS is as follows:

Automatically deployable from a control station within 2 to 4 seconds;

Automatically stowable from a control station within 30 seconds

Manually deployable (from the BCBS module) within 30 seconds;

Manually stow able (from the unit) within 60 seconds;

Designed to withstand:

vertical load (middle of the barrier) of 750 lb (three people hanging); and

horizontal load applied to the barrier of 500 lb. (three people running into it).

Designed with a high level of safety incorporated in both the control system and mechanical system while complying with all applicable codes;

Operated from a Master Control Station, which can control and monitor all barrier modules in a facility or specific zone;

Barrier material is semi-transparent to minimize the stress on children and seniors separated from traveling companions when the barrier is deployed;

Barriers are freestanding based on modules elements being anchored to the floor.

Furthermore, the system meets certain facility integration requirements to ensure that at least one of the concepts is suited for installation in a facility. They include:

Modular configuration with each module approximately 10 feet wide and 8 feet high;

Can be installed in buildings with structural steel frames, concrete floors and suspended ceilings;

Designed to be blended into the aesthetics of the building with minimal aesthetic impact:

from physical perspective (buried in the floor, hidden in single posts, mounted in a full frame); and

from an appearance perspective (i.e. the system can be sheathed in a matching material, painted the same colour, etc.);

Recognizing that different facilities and different applications place more emphasis on some design requirements than others, three BCBS concepts were designed to increase overall suitability for different facilities:

Drop Down BCBS;

Pop Across BCBS; and

Pop Up BCBC.

The three BCBS concepts are considered to be the subject of this patent application.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of a drop down embodiment of the disclosure.

FIG. 2 is a close up internal view of the embodiment of FIG. 1.

FIG. 3 is a perspective view of a cross closing embodiment of the disclosure.

FIG. 4 is a close up internal view of the embodiment of FIG. 3.

FIG. 5 is a perspective view of a spring upwards closing embodiment of the disclosure.

FIG. 6 is a close up internal view of the embodiment of FIG. 5.

### DETAILED DESCRIPTION

### Drop Down BCBS

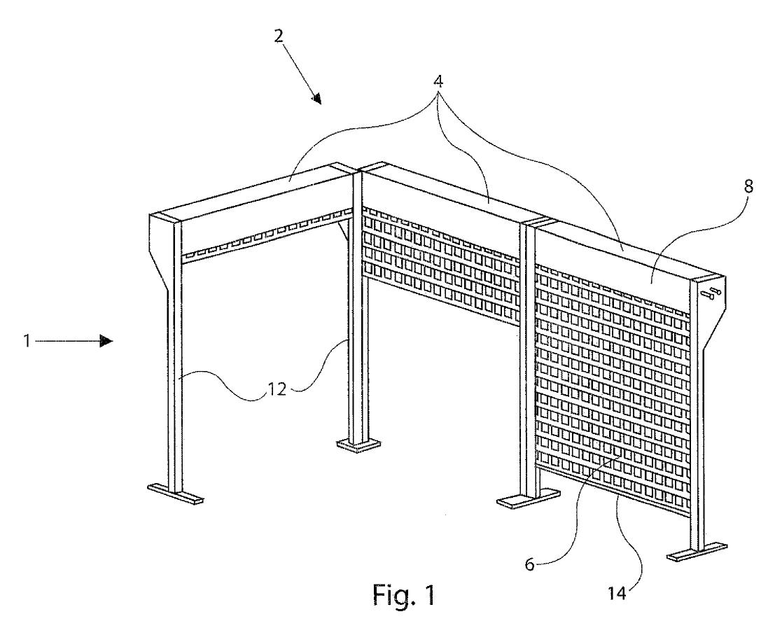

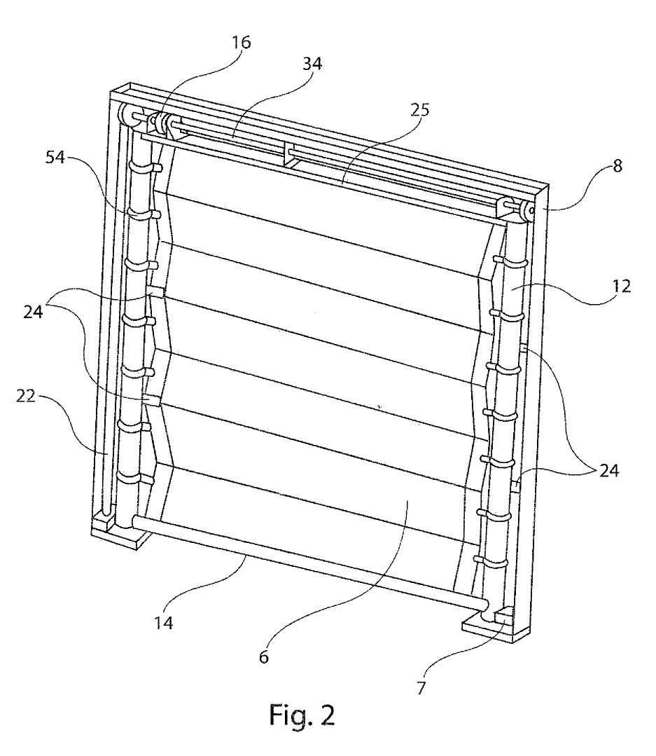

An exemplary embodiment is presented in FIGS. 1-2.

Barrier module frames 2 with overhead frame 4 are permanently installed.

Module frames 2 are “dressed” to match the architectural features of the facility.

Barrier material 6 is stowed in a pleated manner in the overhead storage area 8. Any flexible netting that meets the desired strength and durability specifications for the application may be used as a barrier material 6 including, for example, Kevlar™, vinyl-coated nylon; knotted, knotless, woven, extruded, nylon polyester, polyethylene and similar products.

Barrier material 6 drops when a command is received from the control system.

Barrier material is attached to main guide posts 12 on either side of the barrier 1 preventing intruder from getting between the frame 2 and the material 6.

Barrier material 6 is attached along the full length bar 14 at the lower edge of the material 6. The bar 14 is latched and locked when the barrier is deployed, thereby making it impossible to raise the bar 14 and get under the barrier 1.

Barrier material 6 is connected to the upper frame 4 along the fill length of the material 6, thereby making it impossible to climb between the material 6 and the upper frame 4.

The barrier material 6 is locked in the “stowed” position with an electric brake 16 that is failsafe on, powered to release (deploy).

When the “DEPLOY” button on the Master Control Station is pressed:

The brake 16 releases;

The barrier 1 drops. Note that the horizontal bar 14 at the bottom of the barrier will be made stiff enough to withstand the specified loads. It will also include a layer of padding or protection (similar to a rubber seal on a garage door), to minimize likelihood of injuring people if the barrier contacts a bystander when it is activated. The speed at which the barrier 1 drops will be set to meet the specified deployment (closure) time.

Speed of deployment is controlled by controlling the rate at which air escapes from two linear pneumatic cylinders 22. Pneumatic retarding is provided on this embodiment primarily to offset the effect of gravity. Hence, the pop-up and pop-across embodiments generally do not require any retarding.

Electric eyes 24 integrated into the module frame 2 at two levels sense an object in the plane of the barrier 1 and trigger the brake 16 immediately to stop deployment. The way in which the barrier operates during an interference will depend on the application. In an airport, public safety may be a higher priority, so the brake 16 may hold the barrier 1 once there is an alarm. If security is the higher priority, then the barrier 1 may continue to close once the blockage has cleared.

When the metal bar 14 at the leading edge of the material 6 reaches the bottom of the drop, the bar 14 is automatically locked into position.

The Master Control Station provides the interface for control system which is based on a Programmable Logic Controller (PLC). This system addresses inputs from the electronic eyes 24, latches 7, brake 16, etc.

### Pop Across BCBS

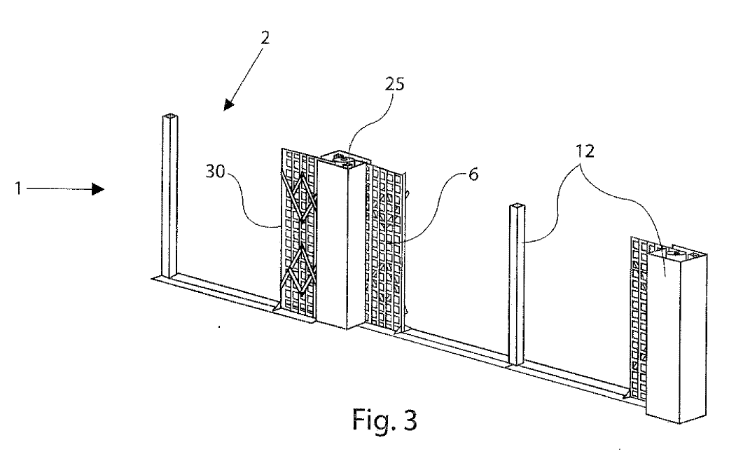

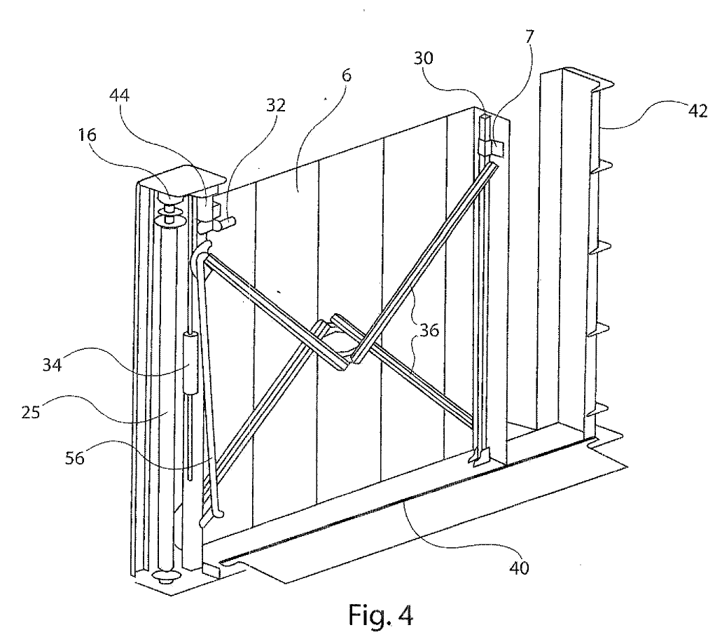

An exemplary embodiment is presented in FIGS. 3-4.

Barrier module frames 2 (posts 12 only) are permanently installed providing clear passage without a height restriction.

Module frames 2 are “dressed” to match the architectural features of the facility.

Barrier material 6 is stowed on a roll 25. Any flexible netting that meets the desired strength and durability specifications for the application may be used as a barrier material including, for example, Kevlar™, vinyl-coated nylon; knotted, knotless, woven, extruded, nylon polyester, polyethylene and similar products.

Barrier material 6 has vertical aluminum slats (not shown) integrated into it to prevent an intruder from passing over or under the barrier 1 while allowing the necessary flexibility to store the barrier material 6 on the roll 25.

Barrier 1 extends from the storage area 8 when a command from the control system is received.

Leading edge 30 of the barrier (moving post) locks against the backside of the adjacent barrier module 2 (stationary post) or against a stationary post 2 adjacent to the wall.

Barrier material 6 is attached along the full length moving post 30 (at the leading edge of the material 6). The moving post 30 is latched and locked to the stationary post 12 when the barrier is deployed, thereby making it very difficult to open the barrier 1.

Barrier material 6 is connected to the roll 25 inside the storage post 8 along the full length of the material 6, thereby making it impossible to climb between the material 6 and the roll 25.

The barrier material 6 is locked in the “stowed” position with an electric brake 16 that is failsafe on, powered to release (deploy).

When the “deploy” button is pressed:

The brake 16 releases.

The “initial accelerator” springs 32 initiate the movement of the barrier 1 from the storage frame 8.

The “arm link accelerator” springs 34 continue to power the barrier 1 across the opening as the scissor mechanism 36 extends.

The barrier 1 is guided across the opening with small rollers 38 in a shallow track 40;

When the barrier 1 is fully deployed the bar on the leading edge 30 of the barrier 1 is locked into the catcher mechanism 42.

When the control system receives a signal indicating that the barrier 1 has been locked at the leading edge 30, the electric recoil gear motor 44 back drives the roller 25 such that the barrier material 6 is tensioned to withstand the specified loads.

Electric eyes 24 at two levels sense an object in the plane of the barrier 1 and lock the brake 16 immediately to stop deployment.

The Master Control Station provides the interface for control system which is based on a Programmable Logic Controller (PLC). This system addresses inputs from the electronic eyes 24, latches 7, brake 16 etc.

### Pop Up BCBS

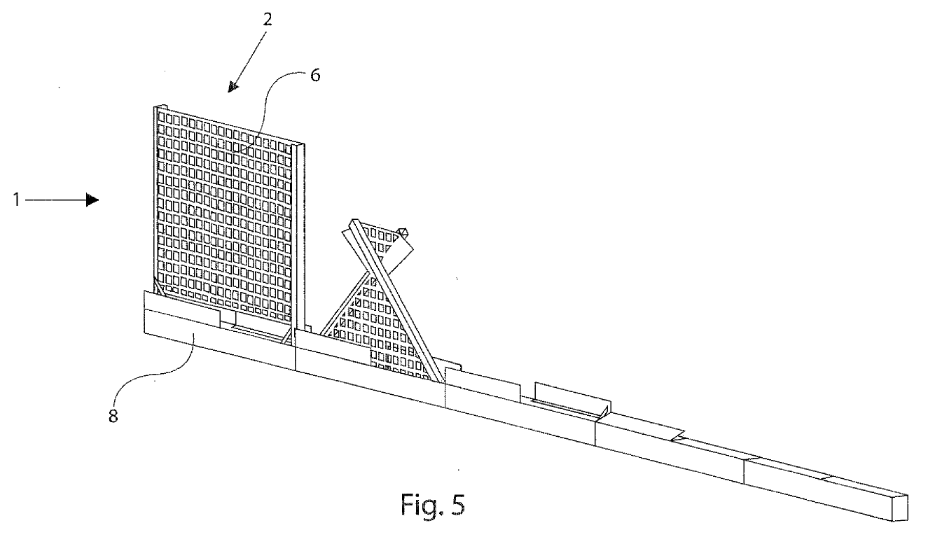

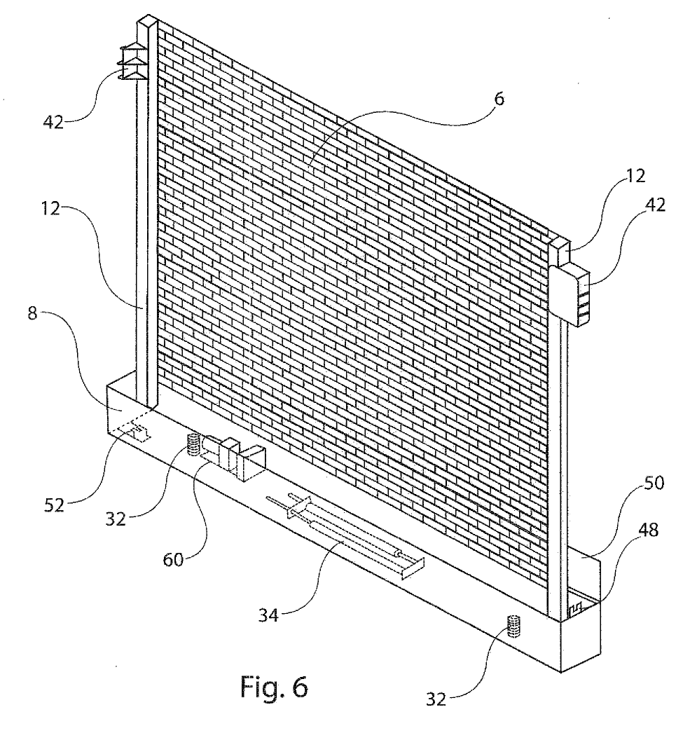

An exemplary embodiment is presented in FIGS. 5-6.

Barrier module frames 2 are permanently installed below floor level in a storage container 8 approximately 14″ square by 10 feet long.

Barrier material 6 is stowed in a folded configuration inside the container 8.

A command from the control system releases solenoid controlled latches 48 on the covers 50 on each module 2. Some degree of positive force is desirable to prevent the covers 50 from accidentally opening when they are walked on, or driven over.

Barrier material 6 is raised out of the storage container 8 on two posts 12.

Posts 12 lock against the matching posts from adjacent modules or a permanently mounted mate on the wall thereby locking a chain of modules together.

Barrier material 6 is attached to a cable (not shown) at the top preventing intruder from getting over the barrier 1 by pulling the material 6 down.

Battier material 6 is attached along the full length arms at either side.

The adjoining posts 12 are latched and locked when the barrier 1 is deployed, making them impossible to move.

Barrier material 6 is connected to the bottom of the container 8 making it impossible to get through or around the barrier 1.

When the “deploy” button is pressed:

The container covers 50 open.

The “launch” springs 32 initiate the movement of the posts 12 and barrier material 6 from the storage container 8.

The “extend” springs 34 continue to power the posts 12 to their fully upright position.

As the adjacent barrier posts rise they lock with each other in the middle of the hallway or against a mating latch next to either wall.

The latch mechanism 48 on the covers 50 will prevent the barrier 1 from being deployed if an object or person is in the plane of the barrier (i.e. on top of the cover).

Electric eyes 24 at two levels mounted on dedicated posts on either side of the hallway/opening will sense an object in the plane of the barrier 1 and prevent the container cover latches 48 from releasing.

The Master Control Station provides the interface for control system which is based on a Programmable Logic Controller (PLC). This system addresses inputs from the electronic eyes 24, latches 7, 48, brake 16 etc.

### Breach Control Barrier System (BCBS)

This Breach Control Barrier System (BCBS) will be used in the following scenario.

In facilities where individuals are screened prior to entry, the area on the downstream side of the screening process is considered “sterile”. All personnel within that area have been screened by security personnel (or have been pre-approved for entry). If a person deliberately or inadvertently bypasses the screening area and enters the “sterile” area it is considered contaminated. A dangerous person or material/device may have been introduced. As a result, the area must be evacuated of all personnel, the area must be inspected to ensure that no dangerous materials/devices have been introduced into the area by the “intruder” and all personnel re-entering the area have to be re-screened prior to reentry.

The present invention will allow security personnel at a screening station (i.e. at an airport) to quickly react to an “intruder” bypassing the screening area by quickly and safely closing the passageways and/or walkways leading from the screening area to the sterile area.

### Operation

### “Drop Down” Breach Control Barrier System

In the operation of the “Drop Down” BCBS the following sequence of events occurs to deploy the barrier if an “intruder” manages to bypass the security screening area on the way to the sterile post-screen area:

The security guard will depress the “DEPLOY” button on the Master Control Station (in which the PLC is incorporated).

The electric brake 16 releases.

The barrier netting 6 begins to drop.

The barrier netting 6 is accelerated to maximum speed with the assistance of the torsion spring 34.

Maximum speed of fall or deployment is controlled by controlling the rate at which air escapes from two linear pneumatic cylinders 22

The barrier curtain 6, initially stowed in a pleated fashion in an upper housing 8, is secured to two structural elements or posts 12 with sliding net securing rings 54.

Electric eyes (transmitters and reflectors) 24 integrated into the module frame 2 at two levels sense an object in the plane of the barrier and trigger the electric brake 16 immediately.

When the bottom locking cross bar 14 at the leading edge of the material 30 reaches the bottom of the drop, the bar 14 is automatically locked into position with the Latch and Catch Securing Crossbar (7).

To retract the barrier, the operator will press the “STOW” button on the Master Control Station:

The latches 7 on the bottom lower crossbar 14 will release.

The electric brake 16 will be released.

A compressed air source will be connected to the barrier 1.

The pneumatic cylinders 22 will retract the barrier 1 into the stowed position thereby retracting the material 6.

While retracting the barrier 1 the torsion spring 34 will be rewound for the next deploy.

When the barrier 1 is fully retracted the electric brake 16 will be reset and the barrier 1 will be ready for the next deploy cycle.

### “Pop Across” Breach Control Barrier System

In the operation of the “Pop Across” BCBS the following sequence of events occurs to deploy the barrier if an “intruder” manages to bypass the security screening area on the way to the sterile post-screen area:

The security guard will depress the “DEPLOY” button on the Master Control Station (in which the PLC is incorporated).

The electric brake 16 releases.

The initial accelerator springs 32 begin to move the arm linkages 12 with the barrier material 6 out of the stowed position.

The barrier material 6 is stored on a roller 25. Aluminum tubular slats (not shown) are incorporated in the material 6 to provide stiffness while allowing the material 6 to roll onto the roll 25.

The draglink 56 synchronizes the movement of the arm linkages 36.

The arm linkage accelerator springs 34 continue to power the barrier 1 across the opening.

The lead edge of the barrier is the moving post 30, which locks against the stationary catcher post 12.

The latches 48 on the moving post 30 lock to the mating catches 42 on the stationary post when the barrier 1 is fully closed.

Once the latches 48 are locked the electric recoil gear motor 44 backwinds the barrier 1 and linkage 56 so the material 6 is tight enough to meet the specified loading requirements. Note that the drop-down systems generally does not need this tension to provide barrier strength since its strength comes from the frame.

The barrier 1 travels across the opening on a grooved track 40 under which run cables for intermodule power and control.

To retract the barrier 1, the operator will press the “STOW” button on the Master Control Station:

The latches 48 on the moving post 30 will be activated and release the catches 42 on the stationary post 12.

The electric recoil gear motor 44 will rewind the material storage roller 38 thereby retracting the material 6 and the arm linkages 56 until the barrier 1 is full retracted.

During the retraction process the initial accelerator springs 32 and the arm linkage accelerator springs 34 will be compressed for the next deploy.

### “Pop Up” Breach Control Barrier System

In the operation of the “Pop Up” BCBS the following sequence of events occurs to deploy the barrier if an “intruder” manages to bypass the security screening area on the way to the sterile post-screen area:

The security guard will depress the “DEPLOY” button on the Master Control Station (in which the PLC is incorporated).

The floor cavity trap door solenoid latch 48 is activated.

The floor cavity trap door 50 is released and opens.

The solenoid releasing latch 52 releases the posts 12.

“Launch” springs 32 initiate movement of the posts upward.

“Extend” springs 34 continue to power the posts 12, which are carrying the material 6, into the vertical position.

As the posts 12 rise into the vertical position they carry the barrier material 6 which is connected along the length of both posts 12.

When the posts 12 arrive at the vertical position they lock with a matching latch 42 on the post 12 from the adjacent module or on a matching latch mounted on or adjacent to the wall.

To retract the barrier 1, the operator will press the “STOW” button on the Master Control Station:

The latches 42 on the posts 12 will release.

The winch for stowing 60 connected to the barrier material 6 will draw the material 6 back into the container 8.

The post latches 52 will lock the posts 12 in the stowed position in the container 8.

The floor cavity trap door 50 will drop and the solenoid latch 48 will lock the trap door 50 in place.

During the retraction process the “extend” springs 32) and “launch” springs 34 will be reloaded for the next deploy.

### Options and Alternatives

While particular embodiments of the present invention have been shown and described, it is clear that changes and modifications may be made to such embodiments without departing from the true scope and spirit of the invention. For example, rather than using springs to drive the barriers to the deployed position, one could use pre-charged pneumatic or hydraulic cylinders, an electric motor with a battery back-up, a counterweight system, or the like. Of course, one could also use the same mechanisms and drivers to return the barriers to the stowed positions. As well, the invention is not limited by the manner of the mechanical linkages and components described.

Other variations on the design include the following:
1. any of the described systems could be implemented to “fail open” or to “fail closed”, depending on the application and the user's requirements;
2. the systems could use low voltage power supplies with battery or UPS (uninterruptible power supply) backup;
3. the described systems could be integrated with existing security systems, various alarms automatically causing deployment;
4. various audible and visual alarm systems can be incorporated to provide a warning to personnel in the area that the system is deploying; and
5. Portable and semi-portable versions of all three embodiments have also been considered to enable the barrier systems to be moved within a facility to best address the facility owner's evolving security requirements.

### Conclusions

The present invention has been described with regard to one or more embodiments. However, it will be apparent to persons skilled in the art that a number of variations and modifications can be made without departing from the scope of the invention.

The present invention has been described with regard to one or more embodiments. However, it will be apparent to persons skilled in the art that a number of variations and modifications can be made without departing from the scope of the invention as defined in the claims. All citations are hereby incorporated by reference.

What is claimed is:

1. A personnel barrier selected from the group consisting of: drop-down, pop across and pop up personnel barriers.

2. The barrier of claim 1 which is automatically deployable from a control station within 2 to 4 seconds.

3. The barrier of claim 1 which is automatically stowable from a control station within 30 seconds.

4. The barrier of claim 1 which is manually deployable (from the BCBS module) within 30 seconds.

5. The barrier of claim 1 which is manually stowable (from the unit) within 60 seconds.

6. The barrier of claim 1 which is modular configuration with each module approximately 10 feet wide and 8 feet high.

7. The barrier of claim 1 for installation in buildings with structural steel frame, concrete floors suspended ceilings.

8. The barrier of claim 1, which is designed to withstand either or both of:
a. vertical load (middle of the barrier) of 750 lb (three people hanging); and
b. horizontal load applied to the barrier of 500 lb. (three people running into it).

9. The barrier of claim 1 which is designed to be blended into the aesthetics of the building.

10. The barrier of claim 1 further comprising a master control/monitoring station for all barrier modules.

11. The barrier of claim 1 complying with a high level of safety in control system and mechanical system.

12. The barrier of claim 1 which is compliant with applicable building and manufacturing codes.

13. The barrier of claim 1, comprising a torsion spring to drive the barrier from a stowed position to a deployed position.

14. The barrier of claim 1, comprising an electric brake to hold the barrier in a stowed position, said electric brake failing to release said barrier, allowing it to deploy.

15. The barrier of claim 1 comprising an electric motor to tension barrier fabric after it has been latched into a deployed position.

16. The barrier of claim 1, further comprising means for stowing said barrier after use.

17. The barrier of claim 1, further comprising a controller to manage operation of said barrier, said controller selected from the group consisting of:
a. a programmable logic controller (PLC);
b. a micro controller;
c. an application specific integrated circuit (ASIC);
d. a microprocessor; or
e. a digital signal processor (DSP).

18. The barrier of claim 1 which is automatically stowable from a control station within 30 seconds.
